(19) United States
(12) Patent Application Publication
(10) Pub. No.: US 2009/0241062 A1
(43) Pub. Date: Sep. 24, 2009

(54) Method for switching function menus in a projector

(75) Inventors: Shao-Pen Lin, Hsin-chu (TW); Tzu-Hai Chung, Hsin-chu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/379,961

(22) Filed: Mar. 5, 2009

(30) Foreign Application Priority Data
Mar. 21, 2008 (TW) 097110134

(51) Int. Cl. G06F 3/048

(52) U.S. Cl. 715/810

(57) ABSTRACT

A method for switching function menus is applied to a projector for the function of on screen display (OSD). The method includes the first step of providing a first function menu, a second function menu and a fuzzy menu. The first function menu has a first picture. The second function menu has a second picture. The fuzzy menu has a fuzzy picture. Specially, the first and the second pictures have an edge which is distinguished by eyes of human beings, but the fuzzy picture has an edge which is undistinguished by eyes of human beings. Subsequently, the first, the fuzzy and the second function menus are switched in sequence at a frequency which is not detected by eyes of human beings, so that the first, the fuzzy and the second pictures are shown in sequence.

### BACKGROUND OF THE INVENTION

(1) Field of the Invention

The present invention relates to a method for switching function menus, particularly to a method for switching function menus applied to a projector for the function of on screen display.

(2) Description of the Prior Art

A general projector provides several function menus having many items such as brightness, contrast, color, display mode etc. for users to adjust the functions or image of the projector.

In adjustment, the user needs to select a function menu and then an item from the function menu. At present, most projectors use a selection block as the background color of the selected function menu or item. The background color is different from that of the unselected function menu or item, so as to highlight the selected function menu or item.

Refer to FIG. 1 for the image of a function menu 100 in a conventional projector. Each function menu 100 has a label 120 and several items 140. The label 120 contains characters 122 or a picture 124. When the function menu 100 is selected, the background color of the label 120 is changed by a selection block 126. Then several items 140 in characters belonging to the selected function menu 100 appear under the label 120 of the selected function menu 100. Similarly, the background color of the selected item 140 is also changed by a selection block 142.

However, though the conventional technology may highlight the selected function menu and its item, the font is not able to be changed, and not vivid enough. Herein, the selection action of the function menu and its item in the projector is improved more active, vigorous and humanized.

### SUMMARY OF THE INVENTION

The present invention is to provide an method for switching function menus of a projector, capable of producing the animation effect and character twinkling effect during switching the function menus.

For achieving one, some or all of the above mentioned object, an embodiment of the present invention is to provide a method for switching function menus which is applied to a projector for the function of on screen display (OSD). The method includes the steps of providing a first function menu, a second function menu and a fuzzy menu, wherein the first function menu has a first picture, the second function menu has a second picture, and the fuzzy menu has a fuzzy picture, both the first and the second pictures have an edge which is distinguished by eyes of human beings, but the fuzzy picture has an edge which is undistinguished by eyes of human beings; and switching in sequence between the first function menu, the fuzzy menu and the second function menu at a frequency which is unable to be detected by eyes of human beings, so that the first, the fuzzy and the second pictures are shown in sequence.

In another embodiment of the present invention, the method includes the steps of providing the first function menu, the second function menu and the fuzzy menu as above; subsequently, providing a display area; displaying the first function menu and the first picture in the display area; closing the first function menu and the first picture; displaying the fuzzy menu and the fuzzy picture in the display area after closing the first function menu; closing the fuzzy menu and the fuzzy picture after displaying the fuzzy menu; and displaying the second function menu and the second picture in the display area after closing the fuzzy menu.

The method further includes displaying the first picture, the fuzzy picture and the second picture in sequence at the same position of the display area.

In an embodiment, the first picture has a first character content, and the second picture has a second character content, both of the first and second character contents having graphic file format. The method provides a contrast color region, surrounding the edge of the first character content or the second character content. When switching to or displaying the second function menu, a color change mechanism is started to change the color of the second character content with time.

Specifically, the first function menu has a plurality of first items, and the second function menu has a plurality of second items. Both the first and the second items have text format. Accordingly, the method provides a plurality of arrow pictures, and plays the arrow pictures continuously to form an animated arrow in the first or second function menus. In the first or second function menu, the animated arrow points close to one of the first items or the second items gradually. Then, a color change mechanism is started to make the color of the first item or the second item pointed by the animated arrow to change with time.

The color change mechanism includes the steps of defining a color change variable; determining whether to increase the value of the color change variable or not; adjusting the color change variable; and according to an adjusted color change variable, setting the red, blue and green in the function of on screen display of the projector respectively.

The step of adjusting the color change variable includes: determining whether the color change variable is in a fixed range; if is, adjusting the value of the color change variable at a predetermined time interval to increase or decrease a value interval; and if not, adjusting the value of the color change variable to one of the two border values of the fixed range and providing an instruction for determining the value of the color change variable increase or decrease.

The above methods use the fuzzy menu and the color change mechanism to produce the animation effect when switching the function menus of the projector, and to produce the character twinkling effect when selecting the item in the function menu.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiment illustrated in the drawings, in which

FIG. 1 is an image of a function menu in a conventional projector.

FIG. 2 is a schematic view showing an embodiment of the function menu according to the present invention.

FIG. 3 is a schematic view showing an embodiment of the fuzzy menu according to the present invention.

FIG. 4A to FIG. 4C are schematic views showing the switching sequence of the function menus according to one embodiment of the present invention.

FIG. 5A to FIG. 5C are schematic views showing the switching sequence of the function menus according to one embodiment of the present invention.

FIG. 6 is a flow chart of switching the function menus according to one embodiment of the present invention.

FIGS. 7A and 7B are schematic views of the shining title and items according to one embodiment of the present invention.

FIG. 8A to 8D are schematic views showing the movement of the dynamic arrows according to one embodiment of the present invention.

FIG. 9A to 9E are schematic views showing the fabrication of the dynamic arrows according to one embodiment of the present invention.

FIG. 10 is a flow chart of a color change mechanism according to one embodiment of the present invention.

FIGS. 11A and 11B are schematic views showing the effect of the color change mechanism according to one embodiment of the present invention.

FIG. 12A to 12C are schematic views showing the timing of using the fuzzy menu according to one embodiment of the present invention.

FIG. 13A to 13C are schematic views showing the timing of using the fuzzy menu according to one embodiment of the present invention.

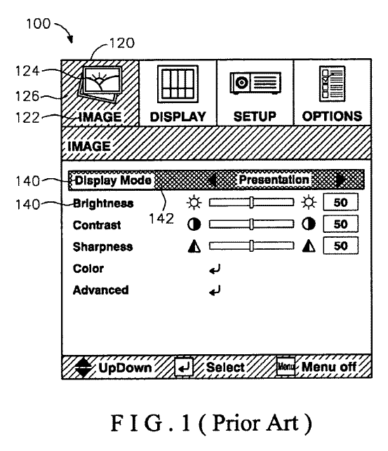

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly facing “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

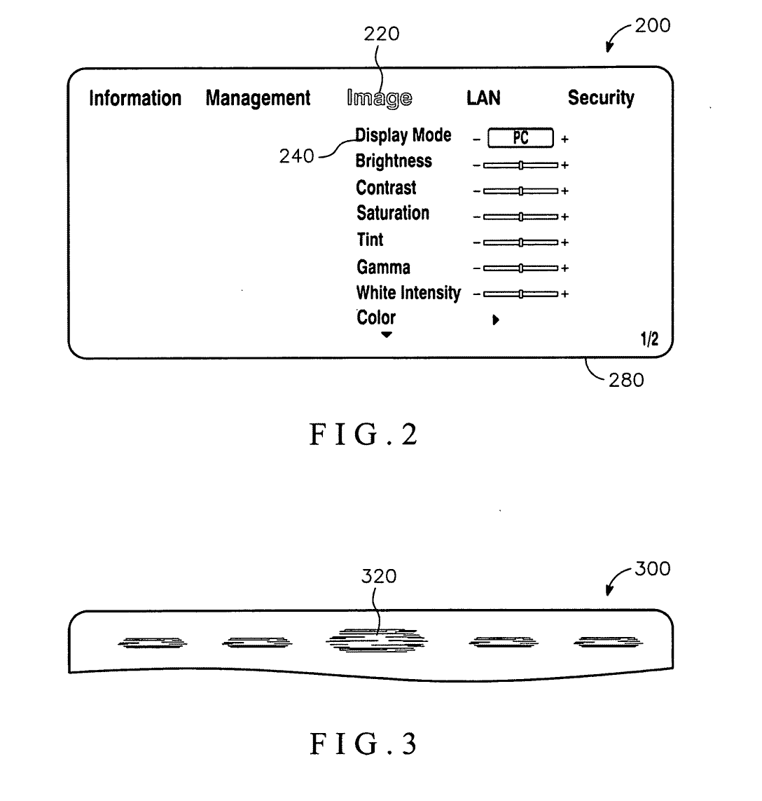

Refer to FIG. 2 for the schematic view of a function menu 200 of a projector. The projector provides a plurality of different function menus 200. Hereinafter, each function menu 200 contains a plurality of titles 220 and items 240, shown in a display area 280. Each title 220 has a character content, such as Information, Management, Image, LAN or Security. Among the plurality of titles 220, at least one character content of the title 220 is contained in a picture processed by graphic software, so the character content has an graphic file format. Each item 240 also has a character content, but in text format, such as Display Mode, Brightness or Contrast etc. For example, the title 220 of ‘Image’ is graphic file format, but its item 240 of ‘Display Mode’ is text format.

Refer to FIG. 3 for the schematic view of a fuzzy menu 300. The fuzzy menu 300 has at least a fuzzy picture 320. Noticeably, the fuzzy picture 320 has an edge which is undistinguished by eyes of human beings.

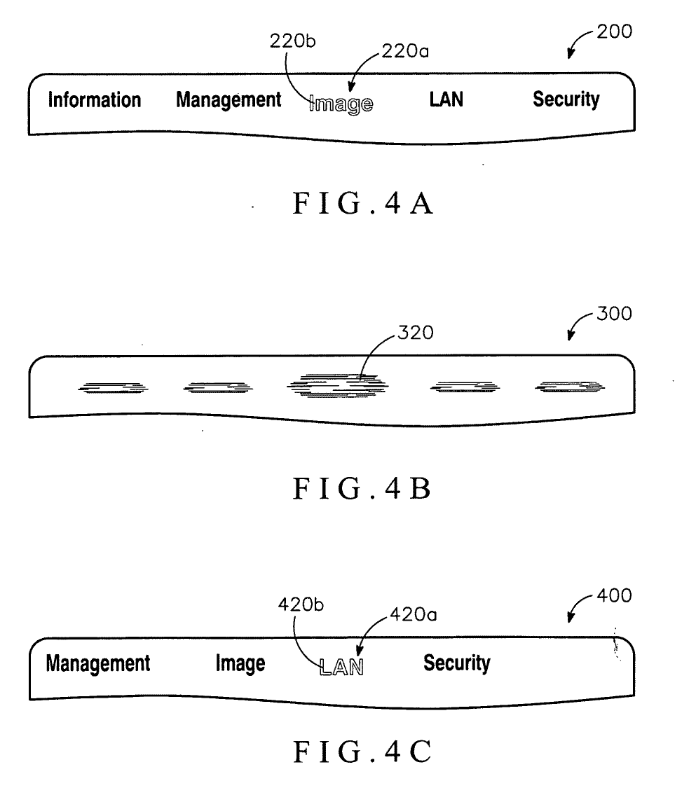

Refer to FIG. 4A to 4C for the embodiment applied to a projector for the function of on screen display (OSD). For convenience, FIG. 4A to 4C display only the title of each menu 200,300 and 400. The menu 200 uses a larger ‘Image’ picture 220a as a main title, meaning the items 240 in the menu 200 are related to the ‘Image’ title 220, so the menu 200 is called ‘Image’ menu 200 below. In the same way, the menu 300 has a larger fuzzy picture 320, and is called fuzzy menu 300 below; the menu 400 uses a larger ‘LAN’ picture 420a as a main title, so is called ‘LAN’ menu 400 below.

When playing, the fuzzy menu 300 may be inserted during the switch of the ‘Image’ menu 200 and the ‘LAN’ menu 400. In other words, if the ‘Image’ picture 220a, the fuzzy picture 320 and the ‘LAN’ picture 420a are switched from FIG. 4A to 4C in sequence at a frequency which is not detected by eyes of human beings, the speed sense of switching the ‘Image’ menu 200 and the ‘LAN’ menu 400 may be made.

In a preferable embodiment, the ‘Image’ picture 220a contains a picture or a character content 220b, and the ‘LAN’ picture 420a also contains a picture or a character content 420b. Noticeably, the character contents 220b and 420b are the words with graph file format.

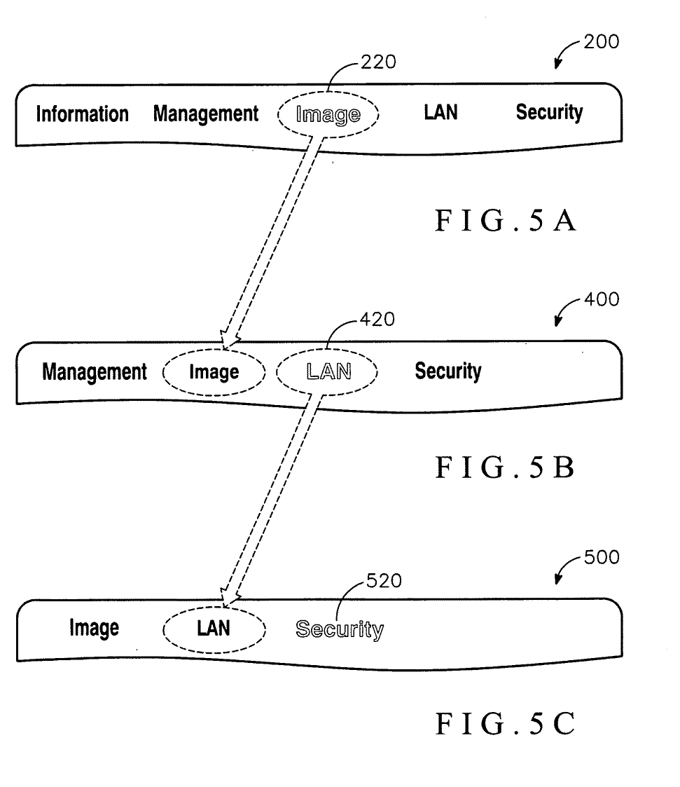

Refer to FIG. 5A to 5C for schematic views of the switching sequence of different function menus 200, 400 and 500. In the function menu 200, the titles from left to right are: Information, Management, Image, LAN, Security. When the ‘Image’ menu 200 is switched to the ‘LAN’ menu 400, the titles from left to right in the ‘LAN’ menu 400 are changed to: Management, Image, LAN, Security. When the ‘LAN’ menu 400 is switched to the ‘Security’ menu 500, the titles from left to right in the ‘Security’ menu 500 are changed to: Image, LAN, Security. From the ‘LAN’ menu 400, the main titles 420 and 520 are moved left and centered to avoid the items in the ‘LAN’ menu 400 and the ‘Security’ menu 500 from overstepping the border.

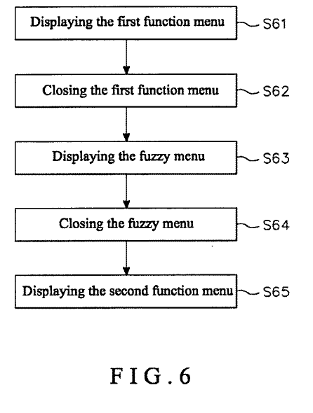

Referring to FIG. 6 for the flow chart of switching the function menu, its steps are: providing a display area, and displaying the first function menu and the first picture in the display area (S61); closing the first function menu and the first picture (S62); after that, displaying a fuzzy menu and a fuzzy picture in the display area (S63); subsequently, closing the fuzzy menu and the fuzzy picture (S64); then displaying a second function menu and a second picture (S65).

The first picture, the fuzzy picture and the second picture are displayed in sequence at the same position of the display area, for example, in FIG. 4A to 4C, the ‘Image’ picture 220a, the fuzzy picture 320 and the ‘LAN’ picture 420a are all displayed above the middle of the display area 280. In the embodiment, the steps displaying and closing the fuzzy menu (S63˜S64) use the animation effect produced by vision delay of human beings to make the speed sense.

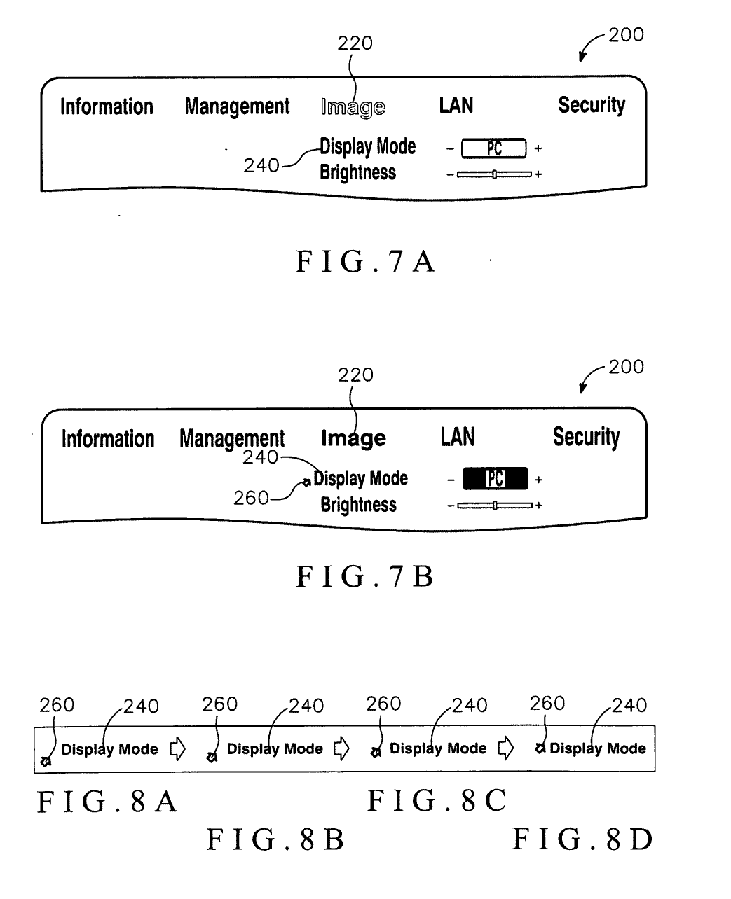

Referring to FIGS. 7A and 7B, in the function menu 200, a dynamic arrow icon 260 points to the current item 240. If the item 240 is in adjustable status, the twinkling and movable dynamic arrow icon 260 appears at the left of the item 240. If the item 240 is not in adjustable status, the twinkling and movable dynamic arrow icon 260 does not appear.

Refer to FIG. 8A to 8D for the schematic views showing the movement of the dynamic arrow icon 260. The applications of the character twinkling effect of the dynamic arrow icon 260 and another item 240 are elaborated as follows.

Referring to FIG. 7B, in the ‘Image’ menu 200, the ‘Image’ title 220 shines and twinkles, and the other titles keep the default colors.

When the user presses the down-key of the adjustable key in the projector, the ‘Image’ title 220 does not shine, and the dynamic arrow icon 260 appears at the left of the ‘Display Mode’ item 240, moving from the down-left side to the up-right side and pointing to the ‘Display Mode’ item 240, so the dynamic arrow icon 260 and the ‘Display Mode’ item 240 both shine and twinkle.

After pressing the up-key, the ‘Display Mode’ item 240 returns to the default grey, and the ‘Image’ title 220 recovers shining and twinkling.

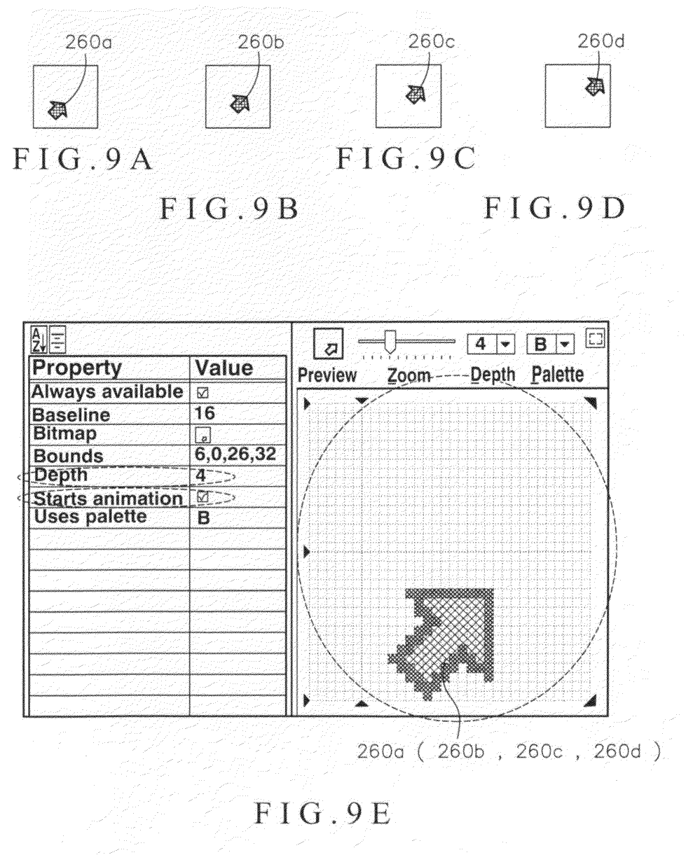

Refer to FIG. 9A to FIG. 9D for schematic views showing the fabrication of the dynamic arrow icon 260. First of all, design four arrow icons 260a, 260b, 260c, 260d and play them at a default frequency in the sequence from FIG. 9A to 9D. It looks like an animated arrow in the view of the user. Here take an example to explain how to make the dynamic arrow icon 260 to move.

Referring to FIG. 9E, first copy the arrow icons 260a, 260b, 260c, 260d to the fonts of a composer software, so that the arrow icons 260a, 260b, 260c, 260d are displayed in the function menus 200, 400 and 500. Then the arrow icons 260a, 260b, 260c, 260d in FIG. 9A to 9D are placed in the continuous memory address in sequence, such as in 0xc9, 0xca, 0xcb and 0xcc. After that, set the first arrow icon 260a, such as hooking the “Starts animation” of the Property column. Later, input the number of the arrow icons in the “Depth” of the Property column for the first arrow icon 260a. For there is only four icons in the embodiment, so input 4. At last, put the first arrow icon 260a where the dynamic arrow icon 260 is expected to appear. Depending on the functions in the TI (Texas Instruments) program, the four arrow icons 260a, 260b, 260c, 260d are played automatically and continuously, thus the dynamic arrow icon 260 is completed. Refer to the attached API for the built-in functions in the TI program.

Hence, the method for switching function menus in this embodiment may further provide a plurality of arrow pictures and play these pictures continuously to form an animated arrow in the function menus 200, 400 and 500.

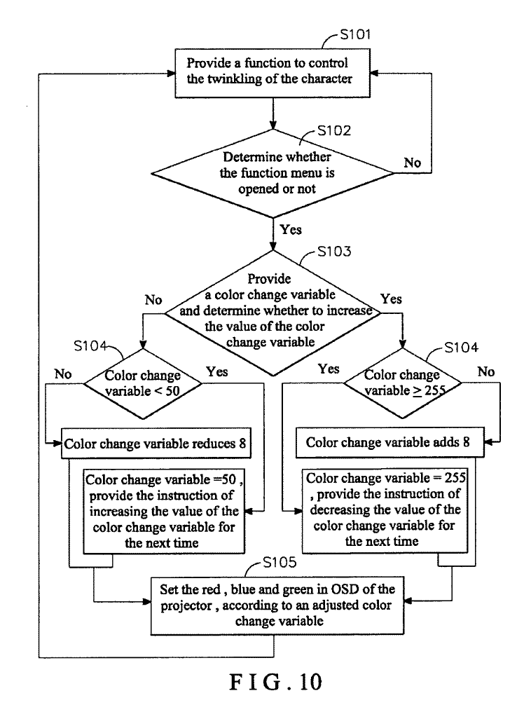

Referring to FIG. 10, all special effects for characters are achieved by color change. Increasing the RGB colors together and then decreasing them together, the character color changes in the order of white, grey, black, grey, white, so that the shining and twinkling effect appears.

This embodiment provides a color change mechanism with following steps.

S101: Provide a function to control the twinkling of the character and call this function at a certain time interval such as 0.1 sec.

S102: Determine whether the function menu is opened or not. If is (TRUE), open the function menu, or if not (FALSE), close the function menu.

S103: Provide a color change variable to determine whether to increase the value of the color change variable or not, namely, to determine whether the current color turns bright. If true, increase the variable, and if false, decrease the variable.

S104: Determine whether the value of the current color change variable is in a fixed range. If is, adjust the value of the color change variable at a predetermined time interval to increase or decrease a value interval.

If not, adjust the color change variable to one of two border values of the fixed range and provide an instruction for determining the value of the color change variable increase or decrease.

For example, if the current color change variable is not in the fixed range, adjust the value of the color change variable to the border value X or Y, and Y>X, X>0, Y>0. If the value of the color change variable is X, provide the instruction of increasing the value of the color change variable for the next time; If the value of the color change variable is Y, provide the instruction of decreasing the value of the color change variable for the next time. In other words, when the color change variable is adjusted to one of the two border values, provide the instruction of increasing or decreasing the variable for the next time. The next instruction is opposite to the current instruction. For example, if the current instruction is increasing, the next instruction is decreasing. On the contrary, if the current instruction is decreasing, the next is increasing.

S105: According to the color change variable adjusted after the step (S104), set the red, blue and green in OSD of the projector and return to the step (S101).

In the embodiment, the color change-variable is between 50 to 255 with an value interval 8, and the two border values of the fixed range are 50 and 255 respectively. The color change variable range and the value interval is set depending on the expected effect of designers. The smaller the value interval is, the smoother the color changes. The variable range decides the display range of the brightest and darkest. The variable 0 stands for dark, 255 for white, between 0 and 255 for grey.

The function menus 200, 400 and 500 twinkle only when they are opened. When the characters turn bright, judge if the color change variable is larger than 255. If true, keep 255 and turn dark next time. If false, add 8 each time to brighten the color. When the characters turn dark, judge if the color change variable is smaller than 50. If true, keep 50 and turn bright next time. If false, reduce 8 each time to darken the color.

In conclusion, in the function menus 200, 400 and 500, the dynamic arrow icon 260 points close to one of the plurality of items gradually, such as the item 240. Then, the color change mechanism is started to make the color of the item 240 pointed by the dynamic arrow icon 260 to change with time.

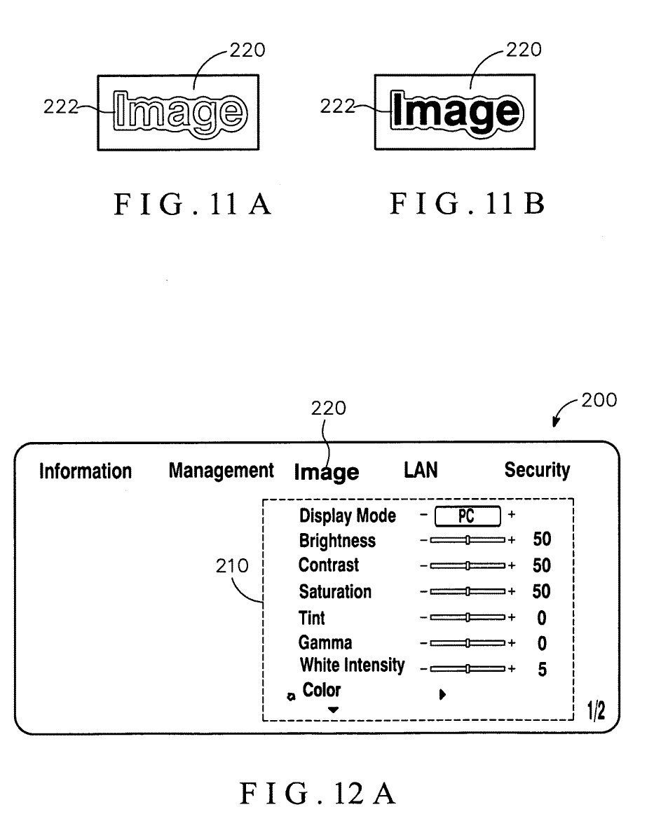

Refer to FIGS. 11A and 11B for schematic views showing the effect of the color change mechanism according to one embodiment of the present invention. The title 220 of the function menu 200 is a picture and may use larger font. The pattern of the character ‘Image’ in the title 220 of the function menu 200 is designed by the graphic software with 32 pixel font height, such as the character is entirely white.

Subsequently, a contrast color region 222 such as a blue region in the embodiment surrounds the edge of the title 220 for highlight. When the characters turn bright, it looks that the blue region becomes dark. When the characters turn dark, the blue region becomes bright relatively. The frequent color change makes twinkling effect. The brightness and twinkling frequency are changed by adjusting the value range and value interval of the color change variable.

In this embodiment, the selected title in the function menu displays large icon, others in general icon (default). For example, in the ‘Image’ menu 200, only ‘Image’ title 200 is displayed in large icon, while in the ‘LAN’ menu 400, the ‘Image’ title 220 turns general icon. In this way, when switching the menu, the characters in the title become large.

To be brief, the color change mechanism of the character or item in the title includes: defining a color change variable; adjusting the color change variable; according to an adjusted color change variable, setting the brightness of the red, blue and green in OSD respectively; then making the three colors to turn bright or dark at the same time at a predetermined time interval according to the value interval of the color change variable. Moreover, when switching from one function menu to another one, the color change mechanism is started to make the character in the title of another function menu to change color with time.

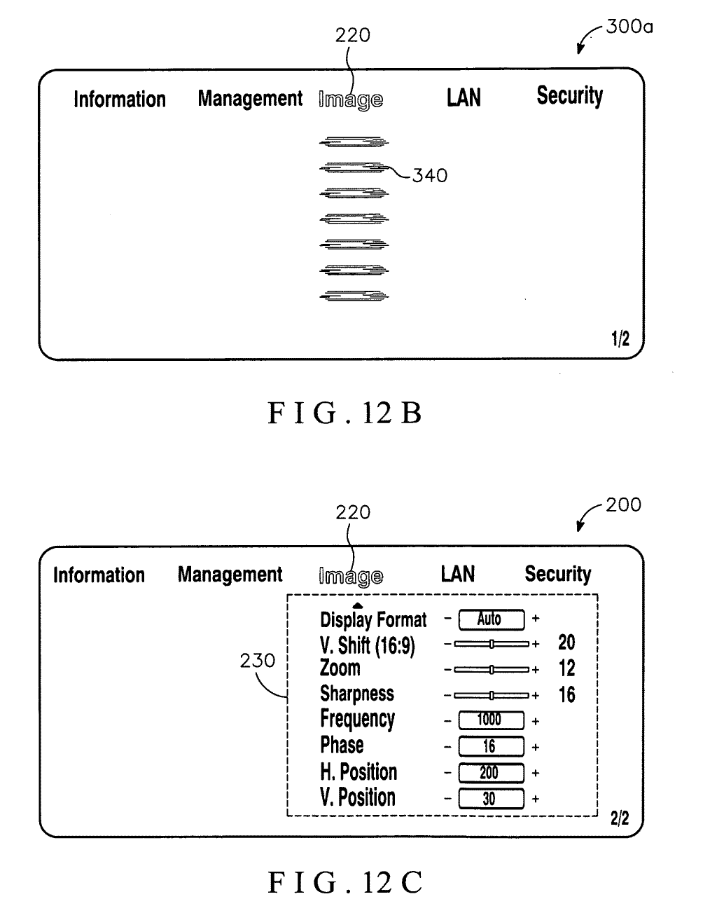

Referring to FIG. 12A to 12C, when the function menu with a certain title has more than one page, such as ‘Image’ menu 200 has two pages 210,230, a fuzzy menu 300a with a plurality of fuzzy items 340 may be inserted during the switch of the first page 210 and the second page 230.

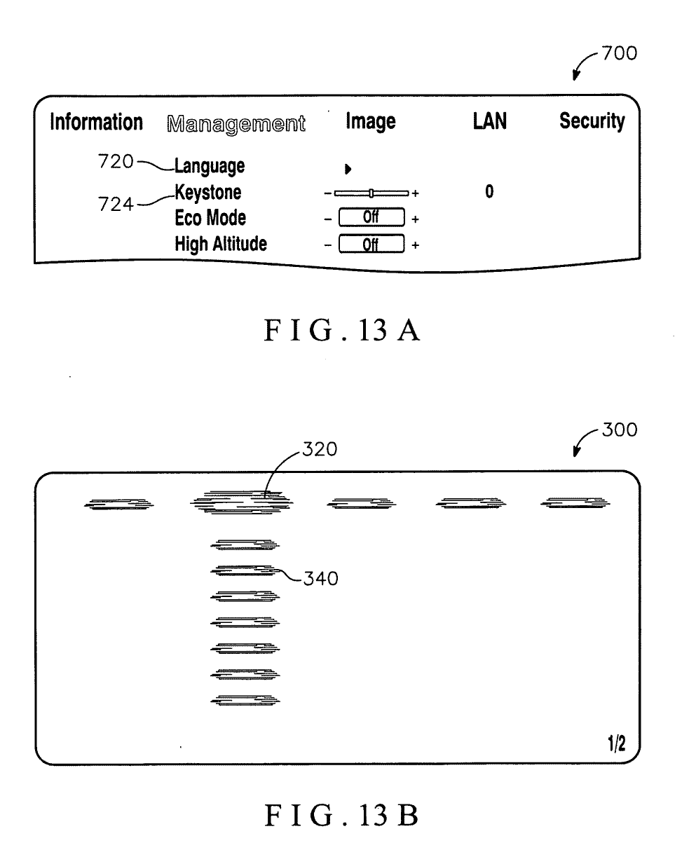

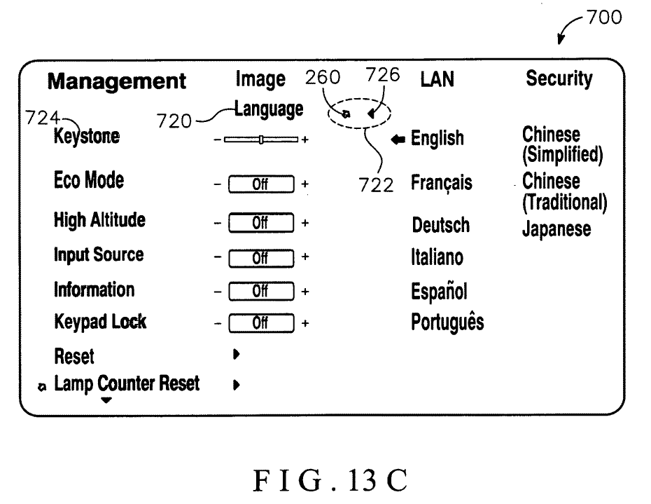

Referring to FIG. 13A to 13C, many subitems are hidden in the ‘Language’ item 720 of the ‘Management’ menu 700 in FIG. 13A, such as ‘English’ subitem 722. If the subitem 722 needs to be displayed during the switch from FIG. 13A to 13C, the fuzzy menu 300 in FIG. 13B may be inserted to produce animation effect. At this time, the color of other item 724 in the ‘Management’ menu 700 turns grey and moves left for space configuration, while the subitem 722 is displayed at right, pointing to the current ‘English’ subitem 722 using a red arrow.

In FIG. 13C, when the dynamic arrow icon 260 points to the left arrow 726 on the topside, press the left key of the projector to return to the ‘Management’ menu 700 in FIG. 13A. During this period, the fuzzy menu 300 made by the fuzzy picture 320 is used.

There are two occasions of utilizing animations in above embodiments:

1. During the switch of menus, the animation effect is produced by inserting the menu made by the fuzzy picture.

2. In a certain menu, when pressing down to a certain item, a dynamic arrow icon appears at the left of the item.

In above embodiments, the timings of utilizing the fuzzy picture are:

1. Switching the menus. For example: the ‘Image’ menu 200 is switched to the ‘LAN’ menu 400.

2. Switching the pages of a certain menus. For example: there are 2 pages in the ‘Image’ menu 200, when the first page is switched to the second page.

3. Displaying the subitems in a certain item.

The above methods are suitable for the firmware program of the projector. The fuzzy menu and the color change mechanism are used to produce animation effect when switching the function menus of the projector, and the characters are twinkling when selecting the item in the function menu. Compared to the conventional technology, it is more vivid and easier to express the subject.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for switching function menus, applied to a projector for the function of on screen display, comprising:
providing a first function menu, a second function menu and a fuzzy menu, wherein the first function menu has a first picture, the second function menu has a second picture, the fuzzy menu has a fuzzy picture, and both the first picture and the second picture have an edge which is distinguished by eyes of human beings, but the fuzzy picture has an edge which is undistinguished by eyes of human beings; and
switching in sequence between the first function menu, the fuzzy menu and the second function menu at a frequency which is unable to be detected by eyes of human beings, so that the first picture, the fuzzy picture and the second picture are shown in sequence.

2. The method for switching function menus of claim 1, wherein the first picture has a first character content, and the second picture has a second character content, both of the first character content and second character content having graphic file format.

3. The method for switching function menus of claim 2, further comprising:
providing a contrast color region, surrounding the edge of the first character content or the second character content.

4. The method for switching function menus of claim 3, further comprising:
when switching to the second function menu, starting a color change mechanism to change the color of the second character content with time.

5. The method for switching function menus of claim 4, wherein the color change mechanism comprises:
defining a color change variable;
determining whether to increase the value of the color change variable or not;
adjusting the color change variable; and
according to an adjusted color change variable, setting the red, blue and green in the function of on screen display of the projector respectively.

6. The method for switching function menus of claim 5, wherein the step of adjusting the color change variable comprises:
determining whether the color change variable is in a fixed range;
if is, adjusting the value of the color change variable at a predetermined time interval to increase or decrease a value interval; and
if not, adjusting the value of the color change variable to one of two border values of the fixed range and providing an instruction for determining the value of the color change variable increase or decrease.

7. The method for switching function menus of claim 1, wherein the first function menu further comprises a plurality of first items, and the second function menu further comprises a plurality of second items, both the first item and the second item having text format.

8. The method for switching function menus of claim 7, further comprising:
providing a plurality of arrow pictures; and
playing the arrow pictures continuously to form an animated arrow in the first function menu or second function menu, and the animated arrow pointing close to one of the first items or the second items gradually.

9. The method for switching function menus of claim 8, further comprising:
starting a color change mechanism to make the color of the first item or the second item pointed by the animated arrow to change with time.

10. The method for switching function menus of claim 9, wherein the color change mechanism comprises:
defining a color change variable;
determining whether to increase the value of the color change variable or not;
determining whether the color change variable is in a fixed range;
if is, adjusting the value of the color change variable at a predetermined time interval to increase or decrease a value interval;
if not, adjusting the value of the color change variable to one of the two border values of the fixed range and providing an instruction for determining the value of the color change variable increase or decrease; and
according to an adjusted color change variable, setting the red, blue and green in the function of on screen display of the projector respectively.

11. A method for switching function menus, applied to a projector for the function of on screen display, comprising:
providing a first function menu, a second function menu and a fuzzy menu, wherein the first function menu has a first picture, the second function menu has a second picture, the fuzzy menu has a fuzzy picture, and both the first picture and the second picture have an edge which is distinguished by eyes of human beings, but the fuzzy picture has an edge which is undistinguished by eyes of human beings;
providing a display area;
displaying the first function menu and the first picture in the display area;
closing the first function menu and the first picture;
displaying the fuzzy menu and the fuzzy picture in the display area after closing the first function menu;
closing the fuzzy menu and the fuzzy picture after displaying the fuzzy menu; and
displaying the second function menu and the second picture in the display area after closing the fuzzy menu.

12. The method for switching function menus of claim 11, wherein the first picture has a first character content, and the second picture has a second character content, both of the first character content and second character content having graphic file format.

13. The method for switching function menus of claim 12, further comprising:
providing a contrast color region, surrounding the edge of the first character content or the second character content.

14. The method for switching function menus of claim 13, further comprising:
when switching to the second function menu, starting a color change mechanism to change the color of the second character content with time.

15. The method for switching function menus of claim 14, wherein the color change mechanism comprises:
defining a color change variable;
determining whether to increase the value of the color change variable or not;
adjusting the color change variable; and
according to an adjusted color change variable, setting the red, blue and green in the function of on screen display of the projector respectively.

16. The method for switching function menus of claim 15, wherein the step of adjusting the color change variable comprises:
determining whether the color change variable is in a fixed range;
if is, adjusting the value of the color change variable at a predetermined time interval to increase or decrease a value interval; and
if not, adjusting the value of the color change variable to one of two border values of the fixed range and providing an instruction for determining the value of the color change variable increase or decrease.

17. The method for switching function menus of claim 11, wherein the first function menu further comprises a plurality of first items, and the second function menu further comprises a plurality of second items, both the first item and the second item having text format.

18. The method for switching function menus of claim 17, further comprising:
providing a plurality of arrow pictures; and
playing the arrow pictures continuously to form an animated arrow in the first function menu or second function menu, and the animated arrow pointing close to one of the first items or the second items gradually.

19. The method for switching function menus of claim 18, further comprising:
starting a color change mechanism to make the color of the first item or the second item pointed by the animated arrow to change with time.

20. The method for switching function menus of claim 19, wherein the color change mechanism comprises:
defining a color change variable;
determining whether to increase the value of the color change variable or not;
determining whether the color change variable is in a fixed range;
if is, adjusting the value of the color change variable at a predetermined time interval to increase or decrease a value interval;
if not, adjusting the value of the color change variable to one of the two border values of the fixed range and providing an instruction for determining the value of the color change variable increase or decrease; and
according to an adjusted color change variable, setting the red, blue and green in the function of on screen display of the projector respectively.
